(19) United States
(12) Patent Application Publication
(10) Pub. No.: US 2026/0029507 A1
(43) Pub. Date: Jan. 29, 2026

(54) METHOD TO ACCOMMODATE A RETRACTABLE ROTATIONAL SURFACE SEARCH RADAR

(71) Applicant: Raytheon Company, Tewksbury, MA (US)

(72) Inventor: Mark F. Parker, WESTPORT, MA (US)

(21) Appl. No.: 18/783,995

(22) Filed: Jul. 25, 2024

(51) Int. Cl. G01S 7/02; B64D 47/00; G01S 13/933

(52) U.S. Cl. CPC G01S 7/027; B64D 47/00; G01S 13/933

(57) ABSTRACT

A radar deployment assembly for a seaplane is provided. The radar deployment assembly includes a lifting assembly, a mounting plate at the lifting assembly, and a radar assembly on the mounting plate. The radar deployment system has a stowed configuration and a deployed configuration. In the stowed configuration, the radar deployment mechanism can be completely within a compartment of an airframe of the seaplane, such as a wing or a fuselage. In the deployed configuration, the radar assembly can extend past an opening in the airframe compartment. The lifting assembly can be a scissor lift assembly having a scissor configuration where the scissor lift assembly is retracted in the stowed configuration and is expanded in the deployed configuration. The lifting assembly can be a hydraulic lift assembly where the hydraulic lift assembly is retracted in the stowed configuration and is expanded in the deployed configuration.

### TECHNICAL FIELD

Examples relate to a radar system for aircraft having marine applications and more specifically to a radar deployment system that deploys and stows an aircraft radar system for aircraft having marine applications.

### BACKGROUND

Aircraft having marine applications typically land and take off from a body of water. In order to assist with navigation and detect objects surrounding the aircraft, radar equipment can be located in a nose radome of the aircraft. The radar equipment can be in the nose in order to maximize the effectiveness of the radar equipment during use. The radar equipment can include weather radar equipment, a radio altimeter, traffic alert and collision avoidance system, a transponder, and a doppler navigation radar. When the aircraft is in the water, such as prior to takeoff, the nose radome can be covered with water, which can limit the effectiveness of radar equipment disposed in the nosecone. Moreover, when the aircraft is in seawater, or any other type of water having an ionic concentration, a conductive medium can be created. The conductivity can damage the radar equipment during use.

### BRIEF DESCRIPTION OF DRAWINGS

FIG. 1 illustrates, by way of example, an aircraft having marine applications.

FIG. 2 shows an airframe compartment of the aircraft of FIG. 1 having a radar assembly disposed therein in a stowed configuration.

FIGS. 3A and 3B show feet of a scissor lift assembly of the radar assembly in FIG. 2 slidingly engaged with a track of a mounting plate of the radar assembly in FIG. 2.

FIG. 4 shows an airframe compartment of the aircraft of FIG. 1 having a radar assembly disposed therein in a deployed configuration.

FIGS. 5A and 5B show a mounting plate of the radar assembly in FIG. 2.

FIG. 6 shows an airframe compartment of the aircraft of FIG. 1 having a radar assembly disposed therein in a stowed configuration.

FIG. 7 shows an airframe compartment of the aircraft of FIG. 1 having a radar assembly disposed therein in a deployed configuration.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to a radar deployment system that can be used with an aircraft having marine applications, such as a seaplane. The radar deployment system can have a stowed configuration and a deployed configuration. In the stowed configuration, the radar deployment system can retract for stowage within a wing or a fuselage of an aircraft. The radar deployment system can extend from the stowed configuration into the deployed position where a radar system of the radar deployment system can extend from the aircraft. In the deployed configuration, the radar system can be used to acquire targets in proximity to the aircraft prior to and during takeoff.

The radar deployment system can include an expansion/retraction system that functions to transition the radar deployment system between a stowed configuration and a deployed configuration. The expansion/retraction system can include a scissor lift operatively coupled with a worm gear where the worm gear can be rotated to move the expansion/retraction system between the stowed and deployed configurations. Alternatively, the expansion/retraction system can include a hydraulic system comprising a hydraulic piston that can be activated to transition between the stowed configuration and the deployed configuration.

The radar system can also have a mounting plate with a seal disposed around a periphery of the mounting plate. The mounting plate can also include a sensor in the form of a switch at the mounting plate periphery. When the radar system is in the deployed configuration, the mounting plate seal can engage a surface of the aircraft to maintain a weather tight seal against the aircraft. The sensor can function to provide an indication when the radar deployment system is in the deployed configuration.

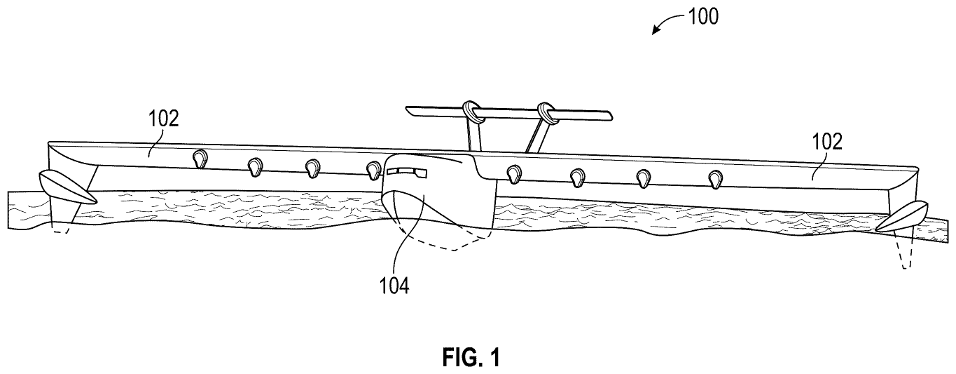

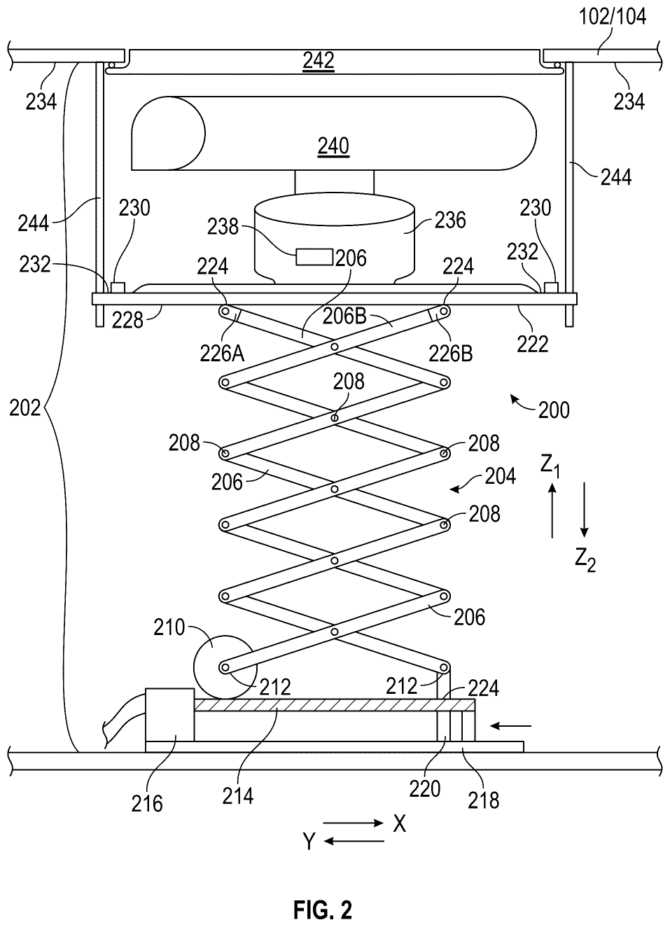

Now referring to FIG. 1, an aircraft 100 having marine applications, such as a seaplane, is shown. The aircraft 100 can include wings 102 along with a fuselage 104. The wings 102 and the fuselage 104 can form an airframe for the aircraft 100 (herein referred to as airframe 102/104). The airframe 102/104 can include an airframe compartment 200 within which a radar deployment assembly 202 can be disposed, as shown in FIG. 2. The airframe compartment 200 can either be in the wing 102 or the fuselage 104.

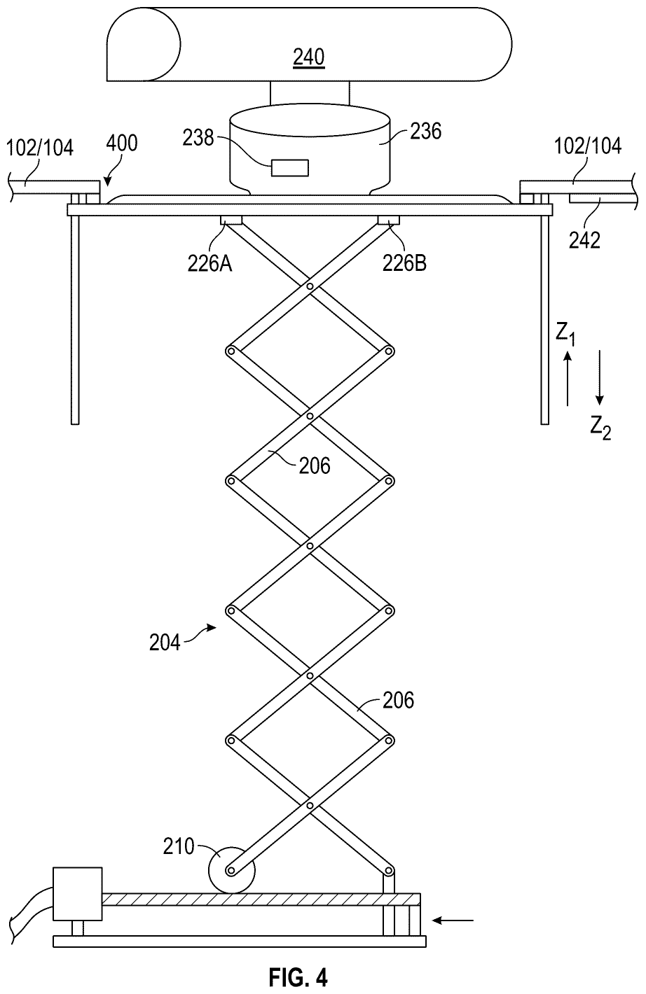

In examples, the radar deployment assembly 202 can include a scissor lift assembly or a hydraulic lift assembly. In FIG. 2, the radar deployment assembly 202 can be a scissor lift assembly 204 having arms 206 coupled to each other with couplings 208 that facilitate rotational coupling between the arms 206 to form a scissor configuration as shown with reference to FIGS. 2 and 4. The radar deployment assembly 202 can have a stowed configuration as shown with reference to FIG. 2 and a deployed configuration as shown with reference to FIG. 4. In order to move between the stowed configuration and the deployed configuration, the scissor lift assembly 204 can include a worm wheel 210 at an end 212 of the scissor lift assembly 204. The worm wheel 210 can be configured to engage with a worm gear 214 that extends from a motor assembly 216, also at the end 212. In examples, the motor assembly 216 can be a power assembly.

The worm wheel 210 can move along either a direction X or a direction Y based on a direction in which the motor assembly 216 rotates the worm gear 214. When the worm wheel 210 moves along the direction X based on the rotation of the worm gear 214, this can cause the scissor lift assembly 204 along with the radar deployment system 202 to move into the deployed configuration where the scissor lift assembly 204 can move along a direction Z₁. When the worm wheel 210 moves along the direction Y based on the rotation of the worm gear 214, this can cause the scissor lift assembly 204 along with the radar deployment system 202 to move into the stowed configuration where the scissor lift assembly 204 can move along the direction Z₂. The motor assembly 216 can function to rotate the worm gear 214 in order to move the scissor lift assembly 204 along either the direction Z₁ or the direction Z₂.

The radar deployment assembly 202 can also include a base 218 to which the motor assembly 216 can rigidly couple. The base 218 can be disposed below the motor assembly 216, as shown in FIG. 2. The scissor lift assembly 204 can also have a fixed connector 220 at the scissor lift assembly end 212 that extends from the scissor lift assembly end 212 opposite the worm wheel 210. The scissor lift assembly fixed connector 220 can include an aperture through which the worm gear 214 extends. Furthermore, the scissor lift assembly fixed connector 220 can rigidly couple with the base 218 using any means, such as a fastener, welding, or the like.

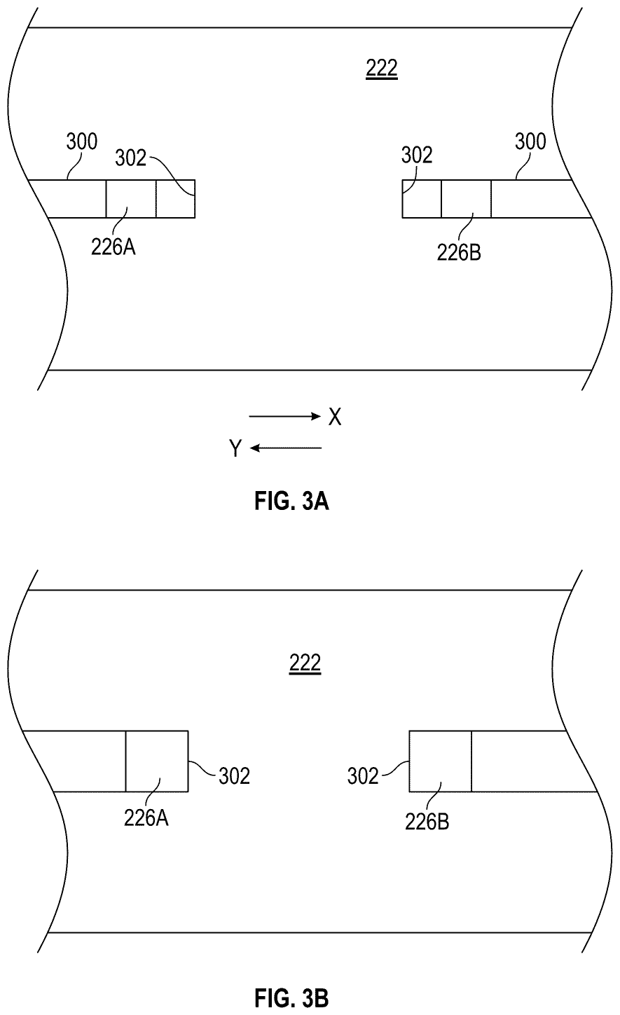

The radar deployment assembly 202 can also include a mounting plate 222 at an end 224 of the scissor lift assembly 204. The mounting plate 222 can operatively couple with the scissor lift assembly 204. More specifically, the scissor lift assembly 204 can include feet 226A and 226B disposed at ends 224 of the arms 206. The scissor lift assembly feet 226A and 226B can be disposed within tracks 300 (FIGS. 3A and 3B) in a surface 228 of the mounting plate 222 and slidingly engage with the tracks 300. When the scissor lift assembly 204 moves along the direction Z₁ between stowed and deployed configurations, the scissor lift assembly foot 226B can slide along the direction Y within the track 300 while the scissor lift assembly foot 226A can slide along the direction X within the track 300. Furthermore, when the scissor lift assembly 204 moves along the direction Z₂ between stowed and deployed configurations, the scissor lift assembly foot 226B can slide along the direction X within the track 300 while the scissor lift assembly foot 226A can slide along the direction Y within the track 300. Moreover, the tracks 300 can define stops 302 where, in some examples, when the scissor lift assembly feet 226A and 226B contact and abut the stops 302, movement along the direction Z₁ will be stopped (FIG. 3B). By virtue of being operatively coupled with the scissor lift assembly 204, when the scissor lift assembly 204 moves along the directions Z₁ and Z₂, the mounting plate 222 also moves along the directions Z₁ and Z₂.

The mounting plate 222 can also include switches 230 at a surface 232 of the mounting plate 222 that is opposite the mounting plate surface 228. The switches 230 can function to indicate when the mounting plate 222 contacts a surface 234 of the airframe 102/104. In particular, the switches 230 can include a push-type mechanism that can be activated when the switches 230 begin contacting the airframe surface 234 (FIG. 4). The switches 230 can send a signal to the motor assembly 216 indicating that the mounting plate 222 is contacting the airframe surface 234 and the motor assembly 216 should discontinue rotating the worm gear 214 and moving the scissor lift assembly 204 along the direction Z₁.

The radar deployment assembly 202 can also include a radar assembly 236 disposed at the mounting plate surface 232. The radar assembly 236 can include electronic navigation instruments 238 along with a rotating antenna 240 that sweeps a beam of microwaves around a water surface that surrounds the aircraft 100. The radar assembly 236 can detect targets with microwaves reflected from the targets and generate displayable images of the targets. Examples of the radar assembly can include radars available from Furuno™ Electronics headquartered in Ashihara-cho, Nishinomiya, Hyōgo Prefecture, Japan.

The airframe 102/104 can include a retractable roof 242 that can move between a closed configuration as shown in FIG. 2 and an open configuration (FIG. 4). In the closed configuration, the retractable roof 242 can enclose the airframe compartment 200 such that the radar deployment assembly 202 can be completely enclosed within the airframe compartment 200. In the open configuration, a retractable roof opening 400 can be formed in the airframe 102/104 through which the radar assembly 236 can extend when in the deployed configuration.

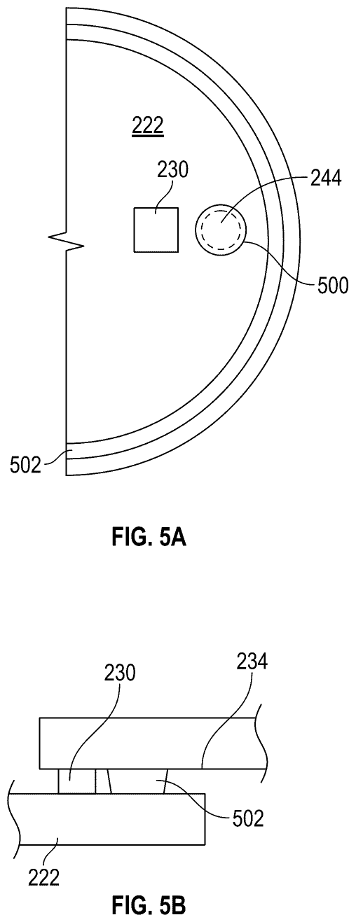

As the scissor lift assembly 204 moves along the direction Z₁, the arms 206 can extend into the deployed configuration as shown in FIG. 4. Moreover, as the scissor lift assembly 204 moves along the direction Z₂, the arms can retract into the stowed configuration as shown in FIG. 2. In order to guide the scissor lift assembly 204 as the arms 206 extend and retract, the scissor lift assembly 204 can have guide rods 244 that extend from the airframe surface 232 towards the base 218. The mounting plate 222 can include apertures 500 (FIG. 5A) through which the guide rods 244 can extend. Thus, as the scissor lift assembly 204 moves along the directions Z₁ and Z₂, the guide rods 224 and the apertures 500 can minimize lateral movement of the scissor lift assembly 204. In examples, the mounting plate apertures 500 can be adjacent the switches 230. When the mounting plate 222 contacts the airframe surface 234, the mounting plate 222 can include a seal 502, which can sealingly engage with the airframe surface 234 when the radar deployment assembly is in the deployed configuration (FIG. 5B).

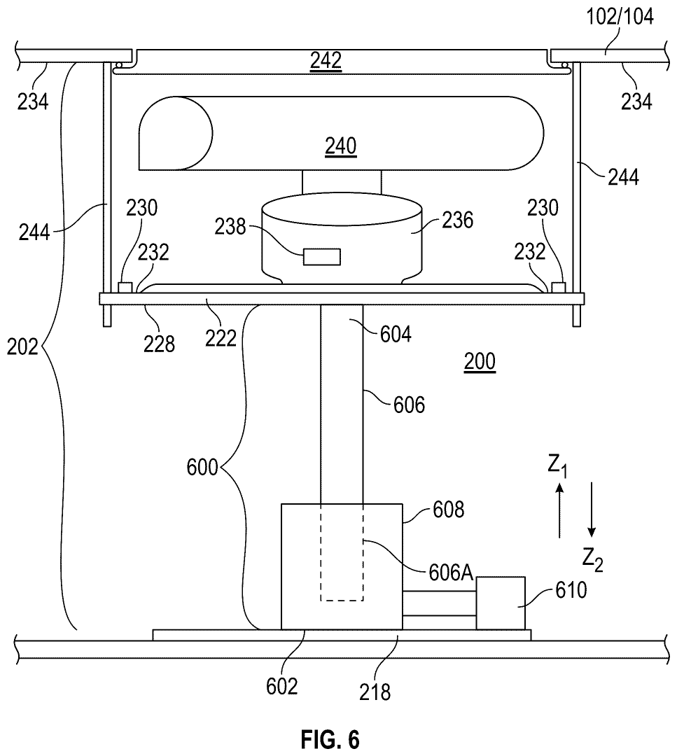

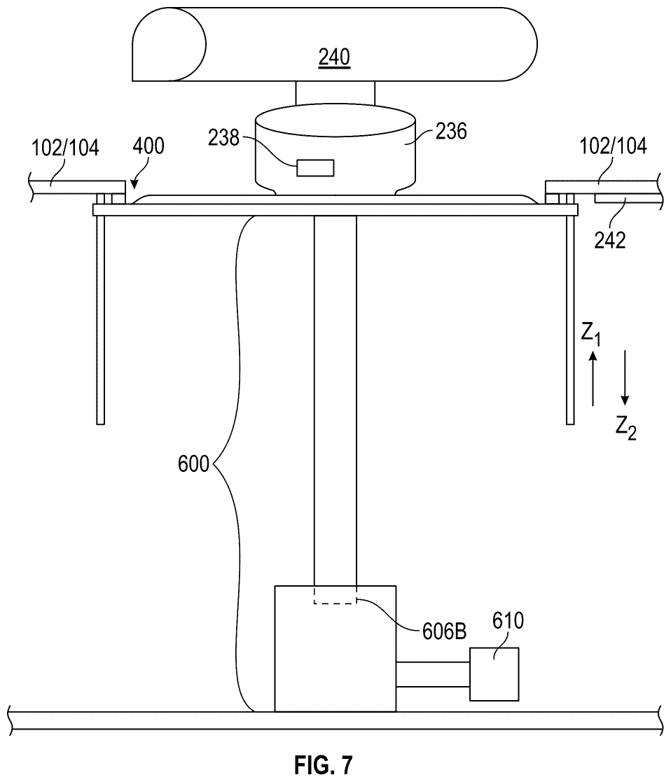

In addition to a scissor lift assembly, the radar deployment assembly 202 can also include a hydraulic lift assembly 600 as shown in FIGS. 6 and 7. Similar to the scissor lift assembly 202, the hydraulic lift assembly 600 can have a stowed configuration (FIG. 6) and a deployed configuration (FIG. 7). The hydraulic lift assembly 600 can have a first end 602 and a second end 604 opposite the first end 602.

The hydraulic lift assembly 600 can include a hydraulic piston 606 partially disposed within and extending from a housing 608 that is at the hydraulic lift assembly first end 602. The hydraulic housing 608 can be in fluid communication with a hydraulic pump 610, which can function to provide hydraulic fluid to the hydraulic housing 608 in order to move the hydraulic piston along the direction Z₁. In examples, the hydraulic pump 610 can be a power assembly. In addition, the hydraulic pump 610 can function to withdraw hydraulic fluid from the hydraulic housing 608 in order to move the hydraulic piston along the direction Z₂. The hydraulic pump 610 can function together with the hydraulic piston 606 to move the hydraulic lift assembly 600 between the stowed configuration and the deployed configuration by removing and providing hydraulic fluid to the hydraulic housing 608. While the hydraulic lift assembly 600 is described as implementing a cylinder circuit, examples envision any type of hydraulic circuit. To further illustrate, the hydraulic lift assembly 600 could use an axial piston pump, a bent axis pump, a radial piston pump, a vane pump, or the like.

The hydraulic lift assembly 600 can rigidly couple to the mounting plate 222 at the hydraulic lift assembly second end 604 as shown in FIG. 6. The hydraulic lift assembly 600 can rigidly couple with the mounting plate surface 228 using any means, such as welding, any type of fastener, or the like. By virtue of the rigid coupling, as the hydraulic lift assembly 600 moves along the directions Z₁ and Z₂, the mounting plate 222 also moves along the directions Z₁ and Z₂. Moreover, the radar assembly 236 can also move along the directions Z₁ and Z₂ with the hydraulic lift assembly 600.

As noted above, the hydraulic lift assembly 600 can have a stowed configuration as shown in FIG. 6 and a deployed configuration, as shown in FIG. 7. In the stowed configuration, the hydraulic pump 610 can be controlled such that a portion 606A of the hydraulic piston 606 is within the hydraulic housing 608 as shown in FIG. 6. Similar to the example in FIG. 2, when the hydraulic lift assembly 600 is in the stowed configuration, the radar deployment assembly 202 can be completely enclosed within the airframe compartment 200.

In the deployed configuration, the hydraulic pump 610 can be controlled such that a portion 606B of the hydraulic piston 606 is within the hydraulic housing 608 as shown in FIG. 7. Similar to the example in FIG. 4, when the hydraulic lift assembly 600 is in the deployed configuration, the radar assembly 236 can extend from the airframe 102/104 through the retractable roof opening 400. In addition, the switches 230 can send a signal to the hydraulic pump 610 indicating that the mounting plate 222 is contacting the airframe surface 234 and the hydraulic pump 610 should discontinue providing hydraulic fluid to the hydraulic housing 208.

### Additional Examples

Example 1 is a radar deployment assembly for a seaplane having an airframe compartment with a retractable roof, the radar deployment assembly comprising: a scissor lift assembly having: a stowed configuration and a deployed configuration; and a first end and a second end, wherein the first end comprises: worm wheel; and a fixed connector opposite the worm wheel; a motor assembly at the scissor lift assembly first end, the motor assembly having a worm gear extending therefrom and engaging with the worm wheel; a base below the motor assembly, the scissor lift assembly fixed connector being rigidly coupled with the base; a mounting plate at the scissor lift assembly second end, the scissor lift assembly being operatively coupled with the mounting plate at a first surface, the mounting plate including a switch disposed at a second surface that opposes the mounting plate first surface; a radar assembly disposed at the mounting plate second surface, the retractable roof having a closed position that encloses the airframe compartment and an open position where an opening is formed in the airframe compartment when the retractable roof is in the open position, wherein when the scissor lift assembly is in the deployed configuration, the radar assembly extends through the opening and when the scissor lift assembly is in the stowed configuration, the scissor lift assembly is enclosed within the airframe compartment and wherein the radar assembly acquires targets in proximity to the aircraft prior to and during takeoff.

In Example 2, the subject matter of Example 1 includes, guide rods extending from a surface of the airframe compartment and into the airframe compartment, the mounting plate including apertures adjacent the switch where the mounting plate apertures slidingly engage with the guide rods.

In Example 3, the subject matter of Examples 1-2 includes, wherein: the mounting plate includes tracks formed in the mounting plate first surface; and the scissor lift assembly includes feet at the scissor lift assembly second end, the scissor lift assembly feet slidingly engaging with the mounting plate tracks and moving within the mounting plate tracks when the scissor lift assembly moves between the stowed configuration and the deployed configuration.

In Example 4, the subject matter of Example 3 includes, wherein the mounting plate tracks define a stop at an end thereof, where the scissor lift assembly is in the deployed configuration when the scissor lift assembly feet abut the mounting plate stop.

In Example 5, the subject matter of Examples 1˜4 includes, wherein the mounting plate includes a seal configured to sealingly engage with the airframe compartment when the scissor lift assembly is in the deployed configuration.

In Example 6, the subject matter of Examples 1-5 includes, wherein the radar assembly includes electronic navigation instruments and a rotating antenna that sweeps a beam of microwaves around a surface that surrounds the airframe compartment.

In Example 7, the subject matter of Examples 1-6 includes, wherein the switch is operatively coupled with the motor assembly and the mounting plate engages a surface of the airframe compartment when the scissor lift assembly is in the deployed configuration where the switch contacts the airframe compartment surface and sends a signal to the motor assembly.

Example 8 is a radar deployment assembly for a seaplane having a airframe compartment with a retractable roof, the radar deployment assembly comprising: a hydraulic lift assembly comprising: a stowed configuration and a deployed configuration; a first end and a second end; a hydraulic housing at the hydraulic lift assembly first end; a hydraulic pump in fluid communication with the hydraulic housing; and a hydraulic piston extending from the hydraulic housing, wherein the hydraulic pump functions to move the hydraulic lift assembly between the stowed configuration and the deployed configuration; a mounting plate at the hydraulic lift assembly second end, the hydraulic lift assembly being rigidly coupled with the mounting plate at a first surface, the mounting plate including a switch disposed at a second surface that opposes the mounting plate first surface; a radar assembly disposed at the mounting plate second surface, the retractable roof having a closed position that encloses the airframe compartment and an open position where an opening is formed in the airframe compartment when the retractable roof is in the open position, wherein when the hydraulic lift assembly is in the deployed configuration, the radar assembly extends through the opening and when the hydraulic lift assembly is in the stowed configuration, the hydraulic lift assembly is enclosed within the airframe compartment and wherein the radar assembly acquires targets in proximity to the aircraft prior to and during takeoff.

In Example 9, the subject matter of Example 8 includes, guide rods extending from a surface of the airframe compartment and into the airframe compartment, the mounting plate including apertures adjacent the switch where the mounting plate apertures slidingly engage with the guide rods.

In Example 10, the subject matter of Examples 8-9 includes, wherein the mounting plate includes a seal configured to sealingly engage with the airframe compartment when the hydraulic lift assembly is in the deployed configuration.

In Example 11, the subject matter of Examples 8-10 includes, wherein the radar assembly includes electronic navigation instruments and a rotating antenna that sweeps a beam of microwaves around a surface that surrounds the airframe compartment.

In Example 12, the subject matter of Examples 8-11 includes, wherein the switch is operatively coupled with hydraulic pump and the mounting plate engages a surface of the airframe compartment when the hydraulic lift assembly is in the deployed configuration where the switch contacts the airframe compartment surface and sends a signal to the hydraulic pump.

Example 13 is a radar deployment assembly for a seaplane having a airframe compartment with a retractable roof, the radar deployment assembly comprising: a lift assembly having a stowed configuration and a deployed configuration, the lift assembly having a first end and a second end; a power assembly at the lift assembly first end, the power assembly operative to move the lift assembly between the stowed configuration and the deployed configuration; a mounting plate at the lift assembly second end, the lift assembly being coupled with the mounting plate at a first surface, the mounting plate including a switch disposed at a second surface that opposes the mounting plate first surface; a radar assembly disposed at the mounting plate second surface, the retractable roof having a closed position that encloses the airframe compartment and an open position where an opening is formed in the airframe compartment when the retractable roof is in the open position, wherein when the lift assembly is in the deployed configuration, the radar assembly extends through the opening and when the lift assembly is in the stowed configuration, the lift assembly is enclosed within the airframe compartment and wherein the radar assembly acquires targets in proximity to the aircraft prior to and during takeoff.

In Example 14, the subject matter of Example 13 includes, wherein the lift assembly is a scissor lift assembly and the first end comprises: worm wheel; and a fixed connector opposite the worm wheel, wherein the power assembly has a worm gear extending therefrom and engaging with the worm wheel.

In Example 15, the subject matter of Example 14 includes, a base below the power assembly and the lift assembly includes a fixed connector where the lift assembly fixed connector is rigidly coupled with the base.

In Example 16, the subject matter of Examples 13-15 includes, guide rods extending from a surface of the airframe compartment and into the airframe compartment.

In Example 17, the subject matter of Example 16 includes, wherein the mounting plate includes apertures adjacent the switch where the mounting plate apertures slidingly engage with the guide rods.

In Example 18, the subject matter of Examples 13-17 includes, wherein the mounting plate includes a seal configured to sealingly engage with the airframe compartment when the lift assembly is in the deployed configuration.

In Example 19, the subject matter of Examples 13-18 includes, wherein the radar assembly includes electronic navigation instruments and a rotating antenna that sweeps a beam of microwaves around a surface that surrounds the airframe compartment.

In Example 20, the subject matter of Examples 13-19 includes, wherein the lift assembly is a hydraulic lift assembly comprising: hydraulic pump at the lift assembly first end; and a hydraulic piston extending from the hydraulic pump, the hydraulic piston being operative to engage the hydraulic pump with hydraulic fluid to move the hydraulic lift assembly between the stowed configuration and the deployed configuration.

Example 21 is a system to implement of any of Examples 1-20.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A radar deployment assembly for a seaplane having an airframe compartment with a retractable roof, the radar deployment assembly comprising:
a scissor lift assembly having:
a stowed configuration and a deployed configuration; and
a first end and a second end, wherein the first end comprises:
worm wheel; and
a fixed connector opposite the worm wheel;
a motor assembly at the scissor lift assembly first end, the motor assembly having a worm gear extending therefrom and engaging with the worm wheel;
a base below the motor assembly, the scissor lift assembly fixed connector being rigidly coupled with the base;
a mounting plate at the scissor lift assembly second end, the scissor lift assembly being operatively coupled with the mounting plate at a first surface, the mounting plate including a switch disposed at a second surface that opposes the mounting plate first surface;
a radar assembly disposed at the mounting plate second surface, the retractable roof having a closed position that encloses the airframe compartment and an open position where an opening is formed in the airframe compartment when the retractable roof is in the open position, wherein when the scissor lift assembly is in the deployed configuration, the radar assembly extends through the opening and when the scissor lift assembly is in the stowed configuration, the scissor lift assembly is enclosed within the airframe compartment and wherein the radar assembly acquires targets in proximity to the aircraft prior to and during takeoff.

2. The radar deployment assembly of claim 1, further comprising guide rods extending from a surface of the airframe compartment and into the airframe compartment, the mounting plate including apertures adjacent the switch where the mounting plate apertures slidingly engage with the guide rods.

3. The radar deployment assembly of claim 1, wherein:
the mounting plate includes tracks formed in the mounting plate first surface; and
the scissor lift assembly includes feet at the scissor lift assembly second end, the scissor lift assembly feet slidingly engaging with the mounting plate tracks and moving within the mounting plate tracks when the scissor lift assembly moves between the stowed configuration and the deployed configuration.

4. The radar deployment assembly of claim 3, wherein the mounting plate tracks define a stop at an end thereof, where the scissor lift assembly is in the deployed configuration when the scissor lift assembly feet abut the mounting plate stop.

5. The radar deployment assembly of claim 1, wherein the mounting plate includes a seal configured to sealingly engage with the airframe compartment when the scissor lift assembly is in the deployed configuration.

6. The radar deployment assembly of claim 1, wherein the radar assembly includes electronic navigation instruments and a rotating antenna that sweeps a beam of microwaves around a surface that surrounds the airframe compartment.

7. The radar deployment assembly of claim 1, wherein the switch is operatively coupled with the motor assembly and the mounting plate engages a surface of the airframe compartment when the scissor lift assembly is in the deployed configuration where the switch contacts the airframe compartment surface and sends a signal to the motor assembly.

8. A radar deployment assembly for a seaplane having a airframe compartment with a retractable roof, the radar deployment assembly comprising:
a hydraulic lift assembly comprising:
a stowed configuration and a deployed configuration;
a first end and a second end;
a hydraulic housing at the hydraulic lift assembly first end;
a hydraulic pump in fluid communication with the hydraulic housing; and
a hydraulic piston extending from the hydraulic housing, wherein the hydraulic pump functions to move the hydraulic lift assembly between the stowed configuration and the deployed configuration;
a mounting plate at the hydraulic lift assembly second end, the hydraulic lift assembly being rigidly coupled with the mounting plate at a first surface, the mounting plate including a switch disposed at a second surface that opposes the mounting plate first surface;
a radar assembly disposed at the mounting plate second surface, the retractable roof having a closed position that encloses the airframe compartment and an open position where an opening is formed in the airframe compartment when the retractable roof is in the open position, wherein when the hydraulic lift assembly is in the deployed configuration, the radar assembly extends through the opening and when the hydraulic lift assembly is in the stowed configuration, the hydraulic lift assembly is enclosed within the airframe compartment and wherein the radar assembly acquires targets in proximity to the aircraft prior to and during takeoff.

9. The radar deployment assembly of claim 8, further comprising guide rods extending from a surface of the airframe compartment and into the airframe compartment, the mounting plate including apertures adjacent the switch where the mounting plate apertures slidingly engage with the guide rods.

10. The radar deployment assembly of claim 8, wherein the mounting plate includes a seal configured to sealingly engage with the airframe compartment when the hydraulic lift assembly is in the deployed configuration.

11. The radar deployment assembly of claim 8, wherein the radar assembly includes electronic navigation instruments and a rotating antenna that sweeps a beam of microwaves around a surface that surrounds the airframe compartment.

12. The radar deployment assembly of claim 8, wherein the switch is operatively coupled with hydraulic pump and the mounting plate engages a surface of the airframe compartment when the hydraulic lift assembly is in the deployed configuration where the switch contacts the airframe compartment surface and sends a signal to the hydraulic pump.

13. A radar deployment assembly for a seaplane having a airframe compartment with a retractable roof, the radar deployment assembly comprising:
a lift assembly having a stowed configuration and a deployed configuration, the lift assembly having a first end and a second end;
a power assembly at the lift assembly first end, the power assembly operative to move the lift assembly between the stowed configuration and the deployed configuration;
a mounting plate at the lift assembly second end, the lift assembly being coupled with the mounting plate at a first surface, the mounting plate including a switch disposed at a second surface that opposes the mounting plate first surface;
a radar assembly disposed at the mounting plate second surface, the retractable roof having a closed position that encloses the airframe compartment and an open position where an opening is formed in the airframe compartment when the retractable roof is in the open position, wherein when the lift assembly is in the deployed configuration, the radar assembly extends through the opening and when the lift assembly is in the stowed configuration, the lift assembly is enclosed within the airframe compartment and wherein the radar assembly acquires targets in proximity to the aircraft prior to and during takeoff.

14. The radar deployment assembly of claim 13, wherein the lift assembly is a scissor lift assembly and the first end comprises:
worm wheel; and
a fixed connector opposite the worm wheel, wherein the power assembly has a worm gear extending therefrom and engaging with the worm wheel.

15. The radar deployment assembly of claim 14, further comprising a base below the power assembly and the lift assembly includes a fixed connector where the lift assembly fixed connector is rigidly coupled with the base.

16. The radar deployment assembly of claim 13, further comprising guide rods extending from a surface of the airframe compartment and into the airframe compartment.

17. The radar deployment assembly of claim 16, wherein the mounting plate includes apertures adjacent the switch where the mounting plate apertures slidingly engage with the guide rods.

18. The radar deployment assembly of claim 13, wherein the mounting plate includes a seal configured to sealingly engage with the airframe compartment when the lift assembly is in the deployed configuration.

19. The radar deployment assembly of claim 13, wherein the radar assembly includes electronic navigation instruments and a rotating antenna that sweeps a beam of microwaves around a surface that surrounds the airframe compartment.

20. The radar deployment assembly of claim 13, wherein the lift assembly is a hydraulic lift assembly comprising:
hydraulic pump at the lift assembly first end; and
a hydraulic piston extending from the hydraulic pump, the hydraulic piston being operative to engage the hydraulic pump with hydraulic fluid to move the hydraulic lift assembly between the stowed configuration and the deployed configuration.
